(19) United States
(12) Patent Application Publication
(10) Pub. No.: US 2012/0216538 A1
(43) Pub. Date: Aug. 30, 2012

(54) STIRLING ENGINE SOLAR CONCENTRATOR SYSTEM

(76) Inventors: Isaac Garaway, Kfar Tavor (IL); Erez Harel, Misgav (IL); Cristina Sosa Naranjo, Seville (ES); Felix Muñoz Gilabert, Seville (ES)

(21) Appl. No.: 13/505,513

(22) PCT Filed: Nov. 1, 2010
(86) PCT No.: PCT/US10/54913

§ 371 Date: May 2, 2012

Related U.S. Application Data
(60) Provisional application No. 61/257,083, filed on Nov. 2, 2009.

(51) Int. Cl. F03G 6/04; F02G 1/055; F03G 6/06

(52) U.S. Cl. 60/641.14; 60/641.15

(57) ABSTRACT

A Stirling engine solar concentrator system including a primary reflector (10) mounted on a base supporting structure (1), a secondary reflector (14) located at a focus of the primary reflector (10). a receiver (18) located at a focus of the secondary reflector (14), wherein sunrays are reflected from the primary reflector (10) to the secondary reflector (14) and are reflected back from the secondary reflector (14) to the receiver (18), and a Stirling engine (5) located near the receiver (18), characterised by a cooling system of the Stirling engine (5) including a plurality of heat transfer elements (6, 8) mounted on a shaded side of the primary reflector (10), wherein a cooling fluid (19) is arranged to flow between the Stirling engine (5) and the heat transfer elements (6, 8).

### FIELD OF THE INVENTION

The present invention relates generally to Stirling dishes solar technology.

### BACKGROUND OF THE INVENTION

Stirling engines have very high efficiencies in their conversion of thermal heat to work. Their ability to be powered by a variety of fuel sources and at high temperatures in excess of 700° C. has made them ideal power converting units for concentrated solar energy. In light of this potential, Stirling-dish solar power converters have been developed in which a reflective parabolic dish structure focuses incoming Direct Normal Irradiation (DNI) on the Stirling engine heat intake port (receiver) which is located in the center of the dish's primary focal point. This same Stirling engine transforms the incoming thermal heat into electricity by means of the Stirling thermal mechanical cycle. Primarily there exist two main genres of Stirling engines; the classical design is the kinematic engine which is based on a rotating shaft with a phase-linking rod which controls the piston placement. The second, more recent and novel engine design is a Free Piston Stirling Engine (FPSE) which relies on the resonant behavior of the piston and displacer within the cycle to control the machine. In either case, the Stirling engine is generally a large and heavy machine which must be supported by the above-mentioned parabolic dish structure. As a result these dish structures are quite robust and are manufactured in such a way so as to stably support this considerable weight and vibration all the while accurately tracking the sun in its daily solar cycle.

In addition to the concentrated heat supplied to the Stirling engine, the Stirling-dish system also requires an ambient cooling element capable of diffusing the rejected heat from the cycle. The cooling system traditionally uses a pump that circulates this cooling fluid through the engine and the radiator. A blower produces the required forced air stream through radiators, to remove the needed heat from the cooling fluid in order that this fluid enters the engine as cold as possible. To compensate the thermal expansion of the fluid, an expansion vessel is used. This cooling system is usually powered by the power produced by the same Stirling engine. It means that the net power transferred to the grid is not the gross power produced by the Stirling engine, since it is necessary to deduct the electricity “wasted” in the cooling system which can reach up to 5% of the produced power.

These multiple sub-components, each with their own elements of cost and reliability have made it difficult for this technology to compete with other concentrated solar power technologies. In order to allow Stirling-dish systems to be competitive there must be serious improvements made in these two sub-components, namely the optimization of the engine position and the cooling system.

### SUMMARY OF THE INVENTION

The present invention seeks to provide an improved Stirling dish technology based on a Stirling engine with solar tracker, which by employing a secondary reflector at the primary focal point would allow the Stirling engine to be placed in the base of the parabolic dish rather than on a supporting arm in the center of the primary reflector focal point. This proposed location and re-orientation of the engine has a number of advantages; it relocates the center of gravity of the dish structure leading to a reduction in the cost of the dish structure and associated tracking motor, and also makes the maintenance of the engine easier, since it is nearer the ground. In addition it allows for the shaded side of the dish to act as the ambient temperature sink for the cold heat exchanger of the engine thus leading to a more robust and inexpensive Stirling engine. However, the use of the shaded side of the primary reflector as a passive cooling system is not limited to structures using a secondary reflector, since it could also be implemented when the Stirling engine is located at the focus of the primary optics by means of flexible pipes connecting the cold side of the motor with this cooling system placed on the shaded surface.

There is provided in accordance with an embodiment of the invention a Stirling engine solar concentrator system including a primary reflector mounted on a base supporting structure, a secondary reflector located at a focus of the primary reflector. a receiver located at a focus of the secondary reflector, wherein sunrays are reflected from the primary reflector to the secondary reflector and are reflected back from the secondary reflector to the receiver, and a Stirling engine located near the receiver, characterised by a cooling system of the Stirling engine including a plurality of heat transfer elements mounted on a shaded side of the primary reflector, wherein a cooling fluid is arranged to flow between the Stirling engine and the heat transfer elements.

In accordance with an embodiment of the invention the Stirling engine is located near where the primary reflector is mounted to the base supporting structure.

In accordance with an embodiment of the invention the Stirling engine is joined to the receiver.

In accordance with an embodiment of the invention the Stirling engine and the receiver form an integrated system that moves by means of a solar tracker.

In accordance with another embodiment of the invention the Stirling engine is located on, and supported by, the base supporting structure, distanced from where the primary reflector is mounted to the base supporting structure.

In accordance with an embodiment of the invention a hot end of the Stirling engine is connected to the receiver by means of flexible lines through which flows a heat transfer fluid.

In accordance with an embodiment of the invention a pump pumps the cooling fluid.

In accordance with an embodiment of the invention the heat transfer elements are located symmetrically about a central axis of the primary reflector.

In accordance with an embodiment of the invention fins extend from the heat transfer elements.

In accordance with an embodiment of the invention the heat transfer elements are attached to the primary reflector with flexible connectors.

In accordance with an embodiment of the invention the flexible connectors are rigid in a transversal direction and flexible in a longitudinal direction.

In accordance with an embodiment of the invention the heat transfer elements are connected to each other through flexible hoses.

In accordance with an embodiment of the invention the heat transfer elements include modular coils.

### BRIEF DESCRIPTION OF THE DRAWINGS

The present invention will be understood and appreciated more fully from the following detailed description taken in conjunction with the drawings in which:

FIG. 1 is a simplified illustration of a complete Stirling dish constructed in accordance with option “a” described below, where the engine is joined to the receiver and both components move together with the structure following the sun.

FIG. 2 is a simplified illustration of a complete Stirling dish constructed in accordance with option “b” described below, where the engine remains vertically with respect to the horizon and the hot side of the motor is connected to a movable receiver (which is mounted within the tracking structure) by means of flexible pipes.

FIG. 3 is a simplified illustration of a modular radiator described below.

FIG. 4 is a simplified illustration of a modular coil, attached behind the mirrored surface.

FIG. 5 is a simplified illustration of the connection between the cooling modules.

FIG. 6 is a simplified illustration of a mechanism that joins the cooling modules to the primary reflector, through L profiles of hinges.

FIG. 7 is a simplified illustration of the location of the cooling modules in the shaded surface of the primary reflector.

FIG. 8 is a simplified illustration of using the shaded side of the primary reflector as a passive cooling system, wherein the Stirling engine is located at the focus of the primary reflector.

### DETAILED DESCRIPTION OF EMBODIMENTS

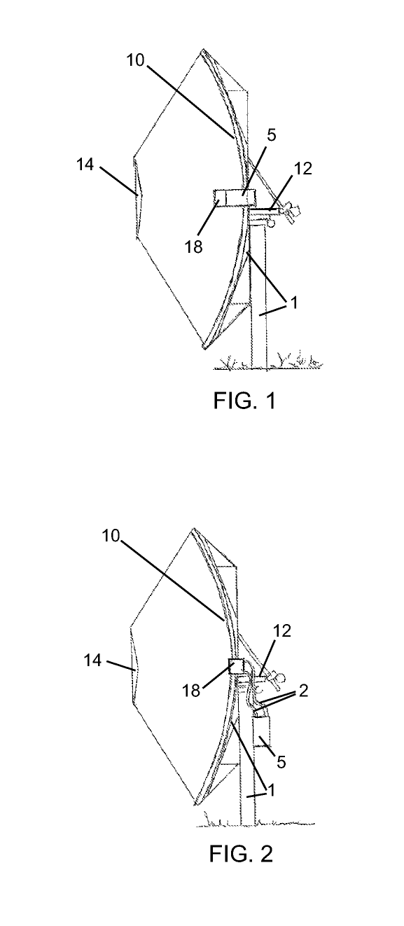

Reference is now made to FIG. 1 and FIG. 2, which illustrate a system with a Stirling engine (5) with solar tracker (12), a primary reflector (10), a secondary reflector (14), and a receiver (18) mounted on a supporting structure (1), constructed and operative in accordance with two non-limiting embodiments of the present invention.

The system includes a primary reflector (mirror or reflective film) (10) that is directed to the sun. The solar tracker (12) moves the system to keep the primary reflector (10) at an optimum position, facing the sun from sunrise to sunset. The sunrays are reflected from the primary reflector (10) to a secondary reflector (14) located at the focus of the primary reflector (10).

The rays are reflected back from the secondary reflector (14) to the receiver (18), located at the focus of the secondary reflector (14). The Stirling engine (5) may be located in close proximity to the receiver (18).

Regarding the location of the Stirling engine (5), two options shall be considered:

a. Locating the Stirling engine (5) joined to the receiver (18), so that both engine (5) and receiver (18) are integrated as only one equipment that moves with the system, by means of the solar tracker (12) and in which the engine (5) and the receiver (18) are inline with the focused rays of solar radiation. This configuration is represented in FIG. 1. In FIG. 1, Sterling engine 5 is located behind receiver 18 (behind meaning away from the sun side).

b. Locating the Stirling engine (5) vertically with respect to the horizon, taking advantage of the earth-mounted solar tracker structure (1) to support the engine body and its linear oscillating power piston. The hot side of the Stirling engine body would be connected to a receiver (18) by means of high temperature, heat resistant flexible lines (2). Receiver (18) is located within the dish focal point, moves with the tracking system, is lightweight, and is insulated to the ambient. The flexible transfer lines (2) carry a heat transfer medium, e.g., the cycle gas itself, or alternatively, a medium different than the cycle gas, such as but not limited to, a heat transfer liquid (e.g., water or oil) or a phase change material. This configuration is represented in FIG. 2.

Option “a” is advantageous in that the engine (5) is located at the center of gravity of the dish structure (1) and can be situated such that the rear cold side of engine coincides with the rear shady side of the dish. This then results in a construction in which the receiver (18) directly intercepts the concentrated radiation, is integrally attached to the hot end of the engine (5) thus reducing heat loss and temperature drops between these two components and yet is also situated to allow its cold end to be directly connected to the ambient heat exchanging surface, i.e. the primary reflector (10).

Option “b” is advantageous in that by situating the engine (5) in a vertical position it significantly reduces side forces and thus friction between the piston(s) of the engine and its/their cylindrical wall(s). In addition, option “b” allows the exported vibrations and the weight of the engine (5) to be absorbed by the main structure (1) and not exported to the moving dish elements (10, 14, 18). These two factors lead to an increase in reliability and decrease in cost both to the engine and to the load carrying tracking system.

The cooling system of the Stirling engine uses a cooling fluid (19, shown flowing in FIG. 5), such as water with antifreeze or other, that flows through the engine with two main objectives: first, to cool critical components of the engine, as the cylinders, the seals or some specific instrumentation that need to maintain their temperature near ambient, and second, to keep the temperature of the cold side of the engine as low as possible, so that in accordance with the Stirling thermodynamic cycle the efficiency of the system would increase.

The cooling system traditionally uses a pump that circulates this cooling fluid through the engine and the radiator. A blower produces the required forced air stream through radiators, to remove the needed heat from the cooling fluid in order that this fluid enters the engine as cold as possible. To compensate the thermal expansion of the fluid, an expansion vessel is used.

This cooling system is usually powered by the power produced by the same Stirling engine. It means that the net power transferred to the grid is not the gross power produced by the Stirling engine, since it is necessary to deduct the electricity “wasted” in the cooling system which can reach up to 5% of the produced power.

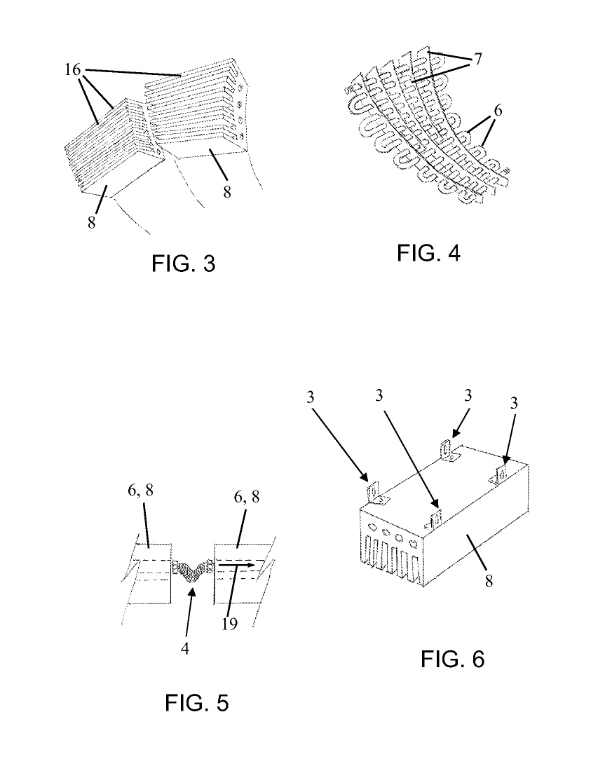

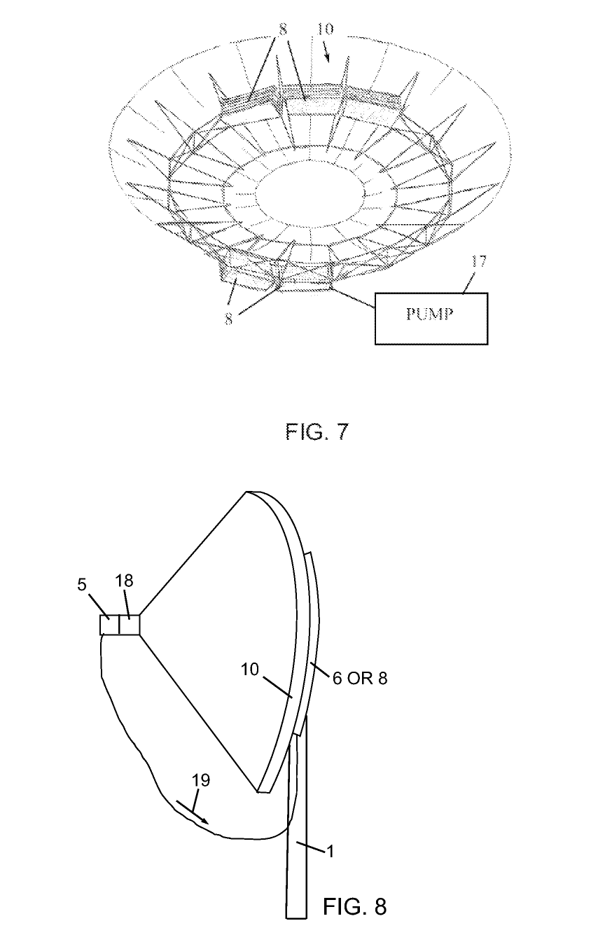

In this invention it is proposed to take advantage of the shaded side of the primary reflector (10) for cooling by covering this surface (partially or fully) with a grid of cooling modules (8), as shown in FIG. 7, through which the cooling fluid circulates by use of a pump (17). In this way, the cooling fluid (water or other) is cooled by means of natural convection; heat transfer takes place between the heat exchanging modules (described below with reference to FIGS. 3 and 4) and the ambient, thus no blower is needed, thereby achieving significant power savings and reduction of mechanical equipment subject to possible failures and maintenance.

The cooling modules (8) grid is designed to evacuate as much heat as possible. Fins (16) could be used to increase the surface exposed to the ambient. The natural convection may sometimes be augmented causing forced convection by means of fans situated near or on the fins located on the backside of the dish (not shown on the drawings), if desired.

Two possible configurations for the application of this system are hereby presented.

1. Modular radiators configuration (FIG. 3): In this configuration, the cooling modules (8) include modular radiators (made of a good heat conductor, such as but not limited to, aluminum or copper) attached to the shaded part of the primary reflector (10). It is noted that the word “radiator” does not mean heat is transferred only by radiation; rather heat is transferred by convection (typically natural, but could also be forced), conduction and radiation.

The radiators are attached to the primary reflector (10) structure with flexible connectors (3), such as but not limited to, L profiles or hinges, as shown in FIG. 6. The flexible connectors (3), which are flexible in at least one direction, such as the longitudinal direction (i.e., the long dimension of the heat transfer element), allow for the cooling modules (8) to move with respect to the supporting structure of the primary reflector (10) so that any mismatch in thermal expansion between the cooling modules (8) and the supporting structure of the primary reflector (10) is borne by the flexibility of the flexible connectors (3) in order not to create stress in the main structure. (For example, flexible connectors (3) may be rigid in the transversal direction and flexible in the longitudinal direction, although other flexible arrangements may also be used.) The radiators (3) float from the structure and follow a radial direction. The radiators (3) are connected one to each other through flexible hoses (4), as shown in FIG. 5, which are screwed to the ducts that drive the cooling fluid in the longitudinal direction. For the design, it is convenient to have only one row (circumferential row) of radiators (3) as close to the center of the primary reflector (10) as possible in order not to generate a higher stress on the structure. If more modules are necessary to dissipate the heat, a second circumferential row of radiators in parallel to the first row could be added. Symmetry about the central axis of the primary reflector (10) is preferable for load balancing.

2. Modular coils configuration (FIG. 4): This configuration is based on modular coils (6) (made of a good heat conductor, such as but not limited to, aluminum or copper) attached behind the mirrored surface. The cooling fluid flows through the coils (6). The coils (6) are attached (e.g., welded) to several flaps (7) to increase the heat transfer to the ambient. In FIG. 4 five flaps are used but this may change according to space or needs. The flaps (7) give the coil self-supporting capacity. Each coil has a screwed end to connect one coil to another. The coil can be mounted symmetrically (about the central axis of the primary reflector (10)) so that the inferior end of one coil can connect with the inferior end of the next one.

Here again, it is noted that the coils transfer heat by convection, conduction and radiation. The term “heat transfer element” is used to encompass the cooling modules (8), the modular coils (6) and any other element useful in cooling the Sterling engine.

Another embodiment of this passive cooling system includes a structure where there is only one reflector element and the Stirling engine is located at the focus of the primary optics. In order for the passive cooling system to function with this type of structure, flexible pipes are attached to the cold side of the motor and connected with this cooling system placed on the shaded surface of the reflector. These flexible pipes for transporting the cooling fluid would be attached to or included within the main support bar of the engine thus benefiting from this existing structural element and not considerably further shading the main dish.

Other configurations or other embodiments for the described cooling module grid could be also developed based on this passive cooling system.

The receiver (18), which is a heat exchanger converting solar energy to thermal energy in the Stirling engine, is a hybrid receiver (18), which can supply heat to the engine from any one or a combination of solar energy, burning fuel (petrol, Diesel, fossil, etc.) or any other independent heat source or combination thereof.

The possibility of using any combination of heat source with solar energy enables operation 24 hours a day without being dependent on the sun as the only heat source.

As mentioned above, the use of the shaded side of the primary reflector as a passive cooling system is not limited to structures using a secondary reflector, since it could also be implemented when the Stirling engine is located at the focus of the primary optics by means of flexible pipes connecting the cold side of the motor with this cooling system placed on the shaded surface. Such an embodiment is now described with reference to FIG. 8.

In this embodiment, the primary reflector (10) is mounted on base supporting structure (1), and the receiver (18) (the Stirling engine heat intake port) is located at the focus of the primary reflector (10). The sunrays are reflected from the primary reflector (10) to the receiver (18). The Stirling engine (5) is located near the receiver (18) (behind it or any other suitable place). The cooling system of Stirling engine (5) includes a plurality of heat transfer elements (6 or 8) mounted on the shaded side of primary reflector (10), wherein a cooling fluid (19) is arranged to flow between the Stirling engine (5) and the heat transfer elements (e.g., with the aid of a pump), as described above for the other embodiments. As with the other embodiments, the invention solves the problem of providing increased heat transfer capability to the Stirling engine solar concentrator system by mounting the heat transfer elements on the shaded side of the primary reflector.

It will be appreciated by persons skilled in the art that the present invention is not limited by what has been particularly disclosed hereinabove. Rather, the scope of the present invention includes both combinations and sub-combinations of the features described hereinabove as well as modifications and variations thereof which would occur to a person of skill in the art upon reading the foregoing description and which are not in the prior art.

1. A Stirling engine solar concentrator system comprising:
a primary reflector (10) mounted on a base supporting structure (1),
a secondary reflector (14) located at a focus of said primary reflector (10).
a receiver (18) located at a focus of said secondary reflector (14), wherein sunrays are reflected from said primary reflector (10) to said secondary reflector (14) and are reflected back from said secondary reflector (14) to said receiver (18); and
a Stirling engine (5) located near said receiver (18);
characterised by a cooling system of said Stirling engine (5) comprising a plurality of heat transfer elements (6, 8) mounted on a shaded side of said primary reflector (10), wherein a cooling fluid (19) is arranged to flow between said Stirling engine (5) and said heat transfer elements (6, 8).

2. The Stirling engine solar concentrator system according to claim 1, wherein said Stirling engine (5) is located near where said primary reflector (10) is mounted to said base supporting structure (1).

3. The Stirling engine solar concentrator system according to claim 1, wherein said Stirling engine (5) is joined to said receiver (18).

4. The Stirling engine solar concentrator system according to claim 1, wherein said Stirling engine (5) and said receiver (18) form an integrated system that moves by means of a solar tracker (12).

5. The Stirling engine solar concentrator system according to claim 2, wherein said Stirling engine (5) is located on, and supported by, said base supporting structure (1), distanced from where said primary reflector (10) is mounted to said base supporting structure (1).

6. The Stirling engine solar concentrator system according to claim 1, wherein a hot end of said Stirling engine (5) is connected to said receiver (18) by means of flexible lines (2) through which flows a heat transfer fluid.

7. The Stirling engine solar concentrator system according to claim 1, further comprising a pump (17) that pumps said cooling fluid (19).

8. The Stirling engine solar concentrator system according to claim 1, wherein said heat transfer elements (6, 8) are located symmetrically about a central axis of said primary reflector (10).

9. The Stirling engine solar concentrator system according to claim 1, wherein fins (16) extend from said heat transfer elements (6, 8).

10. The Stirling engine solar concentrator system according to claim 1, wherein said heat transfer elements (6, 8) are attached to said primary reflector (10) with flexible connectors (3).

11. The Stirling engine solar concentrator system according to claim 10, wherein said flexible connectors (3) are rigid in a transversal direction and flexible in a longitudinal direction.

12. The Stirling engine solar concentrator system according to claim 1, wherein said heat transfer elements (6, 8) are connected to each other through flexible hoses (4).

13. The Stirling engine solar concentrator system according to claim 1, wherein said heat transfer elements (6) comprise modular coils (6).

14. A Stirling engine solar concentrator system comprising:
a primary reflector (10) mounted on a base supporting structure (1),
a receiver (18) located at a focus of said primary reflector (10), wherein sunrays are reflected from said primary reflector (10) to said receiver (18), and
a Stirling engine (5) located near said receiver (18);
characterised by a cooling system of said Stirling engine (5) comprising a plurality of heat transfer elements (6, 8) mounted on a shaded side of said primary reflector (10), wherein a cooling fluid (19) is arranged to flow between said Stirling engine (5) and said heat transfer elements (6, 8).
